(19) United States
(12) Patent Application Publication
(10) Pub. No.: US 2018/0294852 A1
(43) Pub. Date: Oct. 11, 2018

(54) METHOD, COMMUNICATION DEVICE AND COMMUNICATION SYSTEM FOR MIMO COMMUNICATION

(71) Applicant: NATIONAL CHUNG CHENG UNIVERSITY, Chia-Yi County (TW)

(72) Inventors: Chiao-En CHEN, TAICHUNG CITY (TW); Kelvin Kuang-Chi LEE, TAIPEI CITY (TW)

(21) Appl. No.: 15/482,207

(22) Filed: Apr. 7, 2017

(51) Int. Cl. H04B 7/0456; H04B 7/04; H04B 7/005

(52) U.S. Cl. CPC H04B 7/0456; H04B 7/005; H04B 7/0439

(57) ABSTRACT

A method, a communication device and a communication system for multiple-input-multiple-output (MIMO) communication. In the method, Antenna information and channel information of the communication device are obtained. Eigenvalues of an intermediate matrix according to the antenna information and the channel information are determined, where the intermediate matrix is related to an L-term approximated matrix for Neumann series expansion of a matrix inversion, the matrix inversion is an inverse of a K×K matrix, L is a positive integer, and K is a positive integer according to the antenna information. Coefficients of the L-term approximated matrix are determined from the eigenvalues of the intermediate matrix by calculating a coefficient approximation. The matrix inversion according to the L-term approximated matrix with the determined coefficients of the L-term approximated matrix are determined. Accordingly, the precision of matrix inverse approximation (MIA) in MIMO system would be enhanced with low complexity.

### BACKGROUND OF THE DISCLOSURE

### 1. Field of the Disclosure

The present disclosure relates generally to multiple-input-multiple-output (MIMO) communications, and more particularly, to a method, a communication device and communication system for MIMO communication.

### 2. Description of the Related Art

Massive multiple-input-multiple-output (MIMO) has recently emerged as a key technology for the fifth-generation (5G) cellular networks. It is a form of multiple-user MIMO where the number of antennas is much larger than the number of signaling resource. Because the degree of freedom is greatly increased by MIMO configuration, high spectral efficiency can be achieved using simple spatial multiplexing/de-multiplexing schemes. Linear precoding/equalization is one of the simple schemes for massive MIMO systems featuring near-optimal performance at high signal-to-noise-ratio (SNR). However, the complexity of many existing linear precoding/equalization scheme (such as zero-forcing (ZF) and minimum-mean-square-error (MMSE)) grows rapidly with the problem dimension due to the underlying matrix inversion operation, thus exhibiting a major drawback from the implementation perspective. Therefore, providing a low complexity and high precision matrix inverse approximation (MIA) method for massive MIMO applications with becomes critically important for the related industries and researchers.

### SUMMARY OF THE DISCLOSURE

The present disclosure has been accomplished in view of the above-noted circumstances. It is an objective of the present disclosure to provide a method, a communication device and a communication system for MIMO communication, which enhance the precision of MIA in massive MIMO system with low complexity.

To achieve the above objective, the present disclosure provides a method for MIMO communication, which can be adapted for a communication device and comprises the following steps. Antenna information and channel information of the communication device are obtained. Eigenvalues of an intermediate matrix are determined according to the antenna information and the channel information which would be applied to construct an L-term approximated matrix for Neumann series expansion of a matrix inversion The matrix inversion is an inverse of a K×K matrix, where L is a positive integer, and K is a positive integer according to the antenna information. Coefficients of the L-term approximated matrix are deteimined from the eigenvalues of the intermediate matrix by calculating a coefficient approximation which is mathematically expressed as

$$[ \begin{matrix}\frac{1}{1 - {φ}_{1}} \\ \frac{1}{1 - {φ}_{2}} \\ ⋮ \\ \frac{1}{1 - {φ}_{K}}\end{matrix} ] \approx [ \begin{matrix}1 & {φ}_{1} & ⋯ & {φ}_{1}^{L - 1} \\ 1 & {φ}_{2} & ⋯ & {φ}_{2}^{L - 1} \\ ⋮ & ⋮ & ⋮ & ⋮ \\ 1 & {φ}_{K} & ⋯ & {φ}_{K}^{L - 1}\end{matrix} ] [ \begin{matrix}{α}_{0} \\ {α}_{1} \\ ⋮ \\ {α}_{L - 1}\end{matrix} ] ,$$

where ϕ₁˜ϕ_{K} are the eigenvalues of the intermediate matrix, α₁˜α_{K} are the coefficients of the L-term approximated matrix. The matrix inversion according to the L-term approximated matrix with the determined coefficients are determined.

The present disclosure further provides a communication device for MIMO communication which comprises a transmitting module, a receiving module and a processing module. The transmitting module is configured for transmitting data. The receiving is configured for receiving data. The processing module is coupled to the transmitting module and the receiving module. The processing module is configured at least but not limited for i) obtaining antenna information and channel information; ii) determining eigenvalues of an intermediate matrix according the antenna information and the channel information, where the intermediate matrix is related to an L-term approximated matrix for Neumann series expansion of a matrix inversion, the matrix inversion is an inverse of a K×K matrix, L is a positive integer, and K is a positive integer according to the antenna information; iii) determining coefficients of the L-term approximated matrix from the eigenvalues of the intermediate matrix by calculating a coefficient approximation which is mathematically expressed as

$$[ \begin{matrix}\frac{1}{1 - {φ}_{1}} \\ \frac{1}{1 - {φ}_{2}} \\ ⋮ \\ \frac{1}{1 - {φ}_{K}}\end{matrix} ] \approx [ \begin{matrix}1 & {φ}_{1} & ⋯ & {φ}_{1}^{L - 1} \\ 1 & {φ}_{2} & ⋯ & {φ}_{2}^{L - 1} \\ ⋮ & ⋮ & ⋮ & ⋮ \\ 1 & {φ}_{K} & ⋯ & {φ}_{K}^{L - 1}\end{matrix} ] [ \begin{matrix}{α}_{0} \\ {α}_{1} \\ ⋮ \\ {α}_{L - 1}\end{matrix} ] ,$$

where ϕ₁˜θ_{K} are the eigenvalues of the intermediate matrix, α₁˜α_{K} are the coefficients of the L-term approximated matrix; iv) determining the matrix inversion according to the L-term approximated matrix with the determined coefficients.

The present disclosure further provides a communication system for MIMO communication, which comprises a base station and K communication devices. The base station comprises N antennas, where N is a positive integer. Each of the communication devices comprises single antenna, and K is a positive integer. The communication device is configured at least but not limited for i) obtaining antenna information and channel information; ii) determining eigenvalues of an intermediate matrix according the antenna information and the channel information, where the intermediate matrix is related to an L-term approximated matrix for Neumann series expansion of a matrix inversion, the matrix inversion is an inverse of a K×K matrix, L is a positive integer, and K is a positive integer according to the antenna information; iii) determining coefficients of the L-term approximated matrix from the eigenvalues of the intermediate matrix by calculating a coefficient approximation which is mathematically expressed as

$$[ \begin{matrix}\frac{1}{1 - {φ}_{1}} \\ \frac{1}{1 - {φ}_{2}} \\ ⋮ \\ \frac{1}{1 - {φ}_{K}}\end{matrix} ] \approx [ \begin{matrix}1 & {φ}_{1} & ⋯ & {φ}_{1}^{L - 1} \\ 1 & {φ}_{2} & ⋯ & {φ}_{2}^{L - 1} \\ ⋮ & ⋮ & ⋮ & ⋮ \\ 1 & {φ}_{K} & ⋯ & {φ}_{K}^{L - 1}\end{matrix} ] [ \begin{matrix}{α}_{0} \\ {α}_{1} \\ ⋮ \\ {α}_{L - 1}\end{matrix} ] ,$$

where ϕ₁˜_{K} are the eigenvalues of the intermediate matrix, α₁˜α_{K} are the coefficients of the L-term approximated matrix; iv) determining the matrix inversion according to the L-term approximated matrix with the determined coefficients.

Unlike the other MIA methods which are derived mostly from the Neumann series expansion framework, the proposed disclosure introduces additional coefficients optimized to enhance the precision of matrix inverse approximation without increasing computational complexity.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating a communication system according to a preferred embodiment of the present disclosure.

FIG. 2 is a block diagram of a base station according to the preferred embodiment of the present disclosure.

FIG. 3 is a block diagram of one of communication devices according to the preferred embodiment of the present disclosure.

FIG. 4 is a flow chart of a method for MIMO communication according to the preferred embodiment of the present disclosure.

### DETAILED DESCRIPTION OF THE DISCLOSURE

Reference will now be made in detail to the present preferred embodiments of the disclosure, examples of which are illustrated in the accompanying drawings. Wherever possible, the same reference numbers are used in the drawings and the description to refer to the same or like parts.

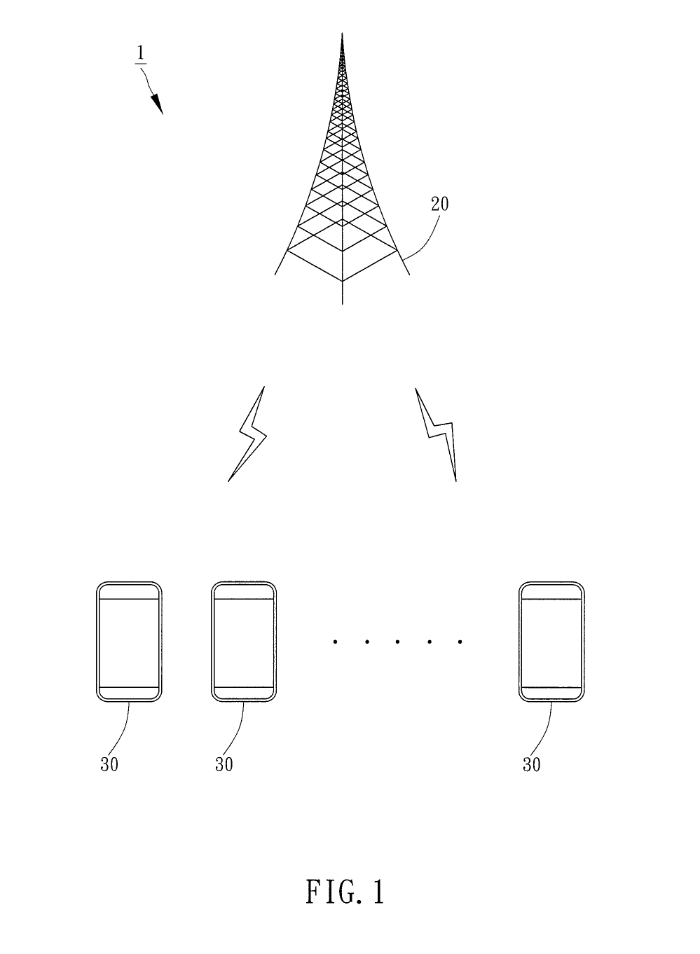

FIG. 1 illustrates a communication system 1 for multiple-input-multiple-output (MIMO) communication according to a preferred embodiment of the present disclosure. Referring to FIG. 1, the communication system 1 may include but not limited to a base station 20 and K user equipments 30, where K is a positive integer.

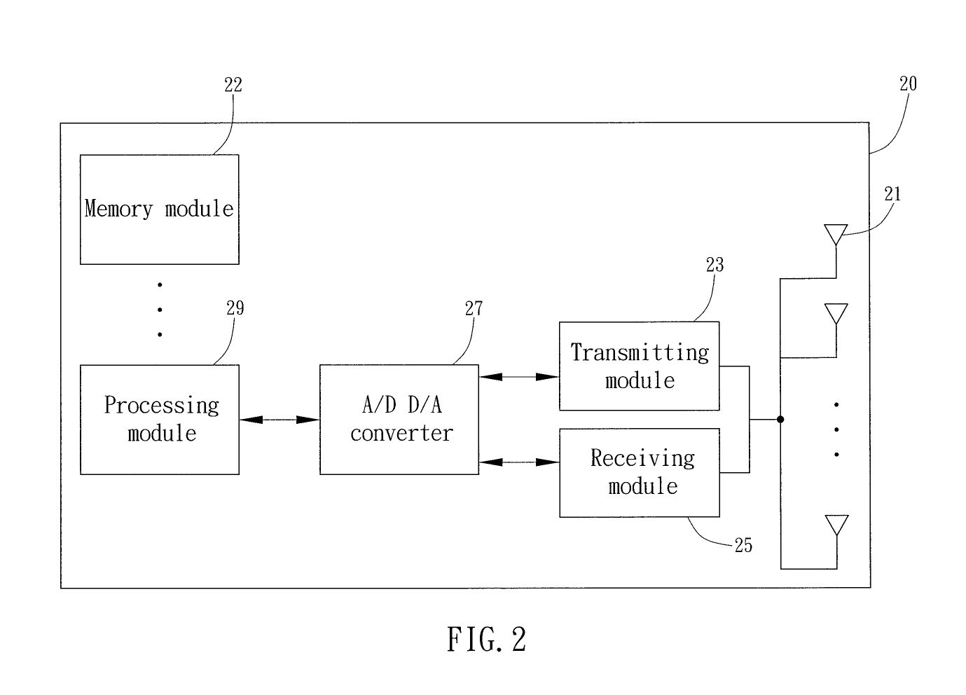

The term “base station” (BS) such as the BS 20 in this disclosure could represent various embodiments which for example could include but not limited to a Home Evolved Node B (HeNB), an eNB, an advanced base station (ABS), a base transceiver system (BTS), an access point, a home base station, a relay station, a scatterer, a repeater, an intermediate node, an intermediary, and/or satellite-based communication base stations. As illustrated in FIG. 2, the BS 20 would include at least but not limited to N antennas 21, a transmitting module 23, a receiving module 25, an analog-to-digital (A/D)/digital-to-analog/(D/A) converter 27 and a processing module 29. The transmitting module 23 and the receiving module 25 are used for transmitting and receiving modulated signals respectively, which could be wireless radio frequency (RF) signals through one or more antennas 21. The transmitting module 23 and the receiving module 25 may also perform operations such as low noise amplifying, impedance matching, frequency mixing, up or down frequency conversion, filtering, amplifying, and other related functions. The A/D and D/A converter 27 is configured to convert an analog signal format to a digital signal format during uplink communication and from a digital signal format to an analog signal format during downlink communication. The processing module 29 is configured to process digital signal and to perform a proposed method for MIMO system described as follows in accordance with exemplary embodiments of the present disclosure. Also, the processing module 29 may optionally be coupled to a non-transitory memory module 22 to store programming codes, configurations, channel information, antenna information, eigenvalues, coefficients, parameters, and so forth. The functions of the processing module 29 could be implemented by using programmable units such as a micro-processor, a micro-controller, a DSP chips, FPGA, etc. The functions of the processing module 29 may also be implemented with separate electronic devices or ICs, and functions performed by the processing module 29 may also be implemented within the domains of either hardware or software.

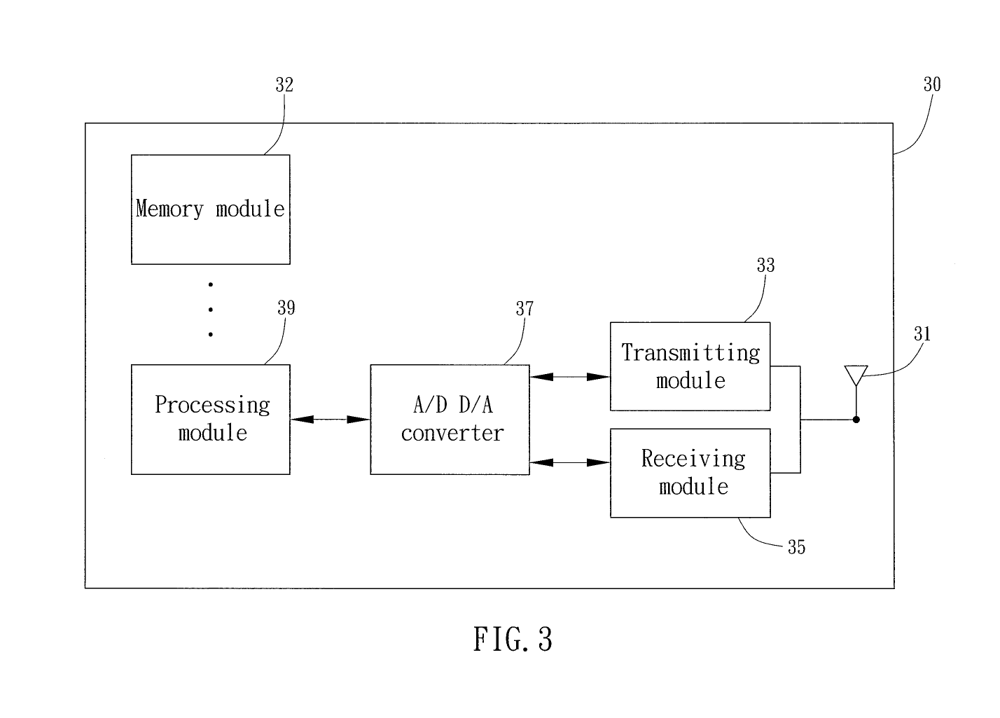

As illustrated in FIG. 3, the term “user equipment” (UE) such as the UEs 30 in this disclosure could represent various embodiments which for example could include but not limited to a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, a mobile/portable communication device and so forth. In some applications, UE 30 may be a fixed device operating in a mobile environment, such as a bus, train, an airplane, a boat, a car, and etc. Each UE 30 may be represented by at least the functional elements as illustrated in FIG. 3 in accordance with an embodiment of the present disclosure. Each UE 30 would include at least but not limited to an antenna 31, a memory module 32, a transmitting module 33, a receiving module 35, an A/D/D/A converter 37 and a processing module 39. The detailed description of functional elements of UE 30 may be referred to the description of functional elements of the BS 20 in FIG. 2, and therefore detailed descriptions for each element will not be repeated.

In one scenario, downlink communication is considered, the processing module 29 of the BS 20 precodes a complex-valued symbol vector s∈ [symbol] ^{K}^{_{×}}¹ to a data vector (x=Fs) by a linear precoder (F=β\tilde{F}, \tilde{F}∈ [symbol] ^{N}^{_{×}}^{K}, β=\sqrt{P}/∥\tilde{F}∥_{F}) and then transmits the data vector x through the transmitting module 23 and the antennas 21 over a downlink channel. It is assumed that the components of s are normalized to unit energy. The matrix \tilde{F} denotes an unnormalized precoder, and β is a power scaling factor to restrain total transmit power E{∥x∥²}=P. If a channel matrix H_{DL} ∈ [symbol] ^{K}^{_{×}}^{N} for the downlink channel is considered, the unnormalized precoder using zero-forcing (ZF) precoding would be represented as \tilde{F}=H_{DL}^{H}(H_{DL}H_{DL}^{H})⁻¹.

On the other hand, in another scenario where uplink communication is considered, the received data vector over a uplink channel by the receiving module 25 of the BS 20 can be concisely described as y_{BS}=H_{UL}s+w_{BS}, where H_{UL}∈ [symbol] ^{N}^{_{×}}^{K} denotes the channel matrix for the uplink channel, and w_{BS} is noise vector. It is assumed that a linear detection is deployed by the processing module 29 of the BS 20, the detected symbol from the kth UE 30 is obtained as ŝₖ=Q([Wy_{BS}]ₖ), where Q(.) denotes the operation that quantizes each element of the input vector to the nearest symbol in a constellation set, and W∈ [symbol] ^{K}^{_{×}}^{N} denotes an equalizer of the BS 20. If a ZF equalization is implemented, the equalizer would be represented as W=(H_{UL}^{H}H_{UL})⁻¹ H_{UL}^{H}.

According to the aforementioned scenarios, for both equalizer and precoder implementing ZF equalization/precoding, the matrix inverse operation for (H_{DL}H_{DL}^{H})⁻¹ and (H_{UL}^{H}H_{UL})⁻¹ may need to be performed by the processing module 29 of the BS 20. Therefore, providing a method for the matrix inverse operation with high precision and low complexity would be an objective which communication relevant industries and researchers want to achieve. The following description would introduce the proposed method for the matrix inverse operation briefly. For convenience, in the following description, the BS 20 would be considered as an exemplary entity for implementing the proposed method of the disclosure. In addition, it is defined that a channel matrix H [symbol] H_{UL} for uplink transmission and H [symbol] H_{DL} for downlink transmission, and a matrix inversion is considered as G⁻¹ which is an inverse of a K×K matrix G (G [symbol] H^{H}H). With the aforementioned notation, both uplink and downlink scenarios would be investigated under a unified context.

Neumann series expansion of the matrix inversion G⁻¹ can be mathematically expressed as follows:

$${G}^{- 1} = {\sum }_{l = 0}^{∞} {( - {D}^{- 1} E )}^{l} {D}^{- 1} , \qquad ( 1 )$$

where D is a diagonal matrix related to the K×K matrix G in which D=diag{[G]_{1,1}, [G]_{2,2}, . . . , [G]_{K,K}}, E is an off diagonal matrix related to the K×K matrix G in which G=D+E.

An L-term Neumann series expansion is used as an approximation for to the matrix inversion G⁻¹, and the L-term Neumann series expansion of the matrix inversion G⁻¹ can be mathematically expressed as follow:

$${G}^{- 1} ≅ {\sum }_{l = 0}^{L - 1} {( - {D}^{- 1} E )}^{l} {D}^{- 1} , \qquad ( 2 )$$

where L is a finite positive integer.

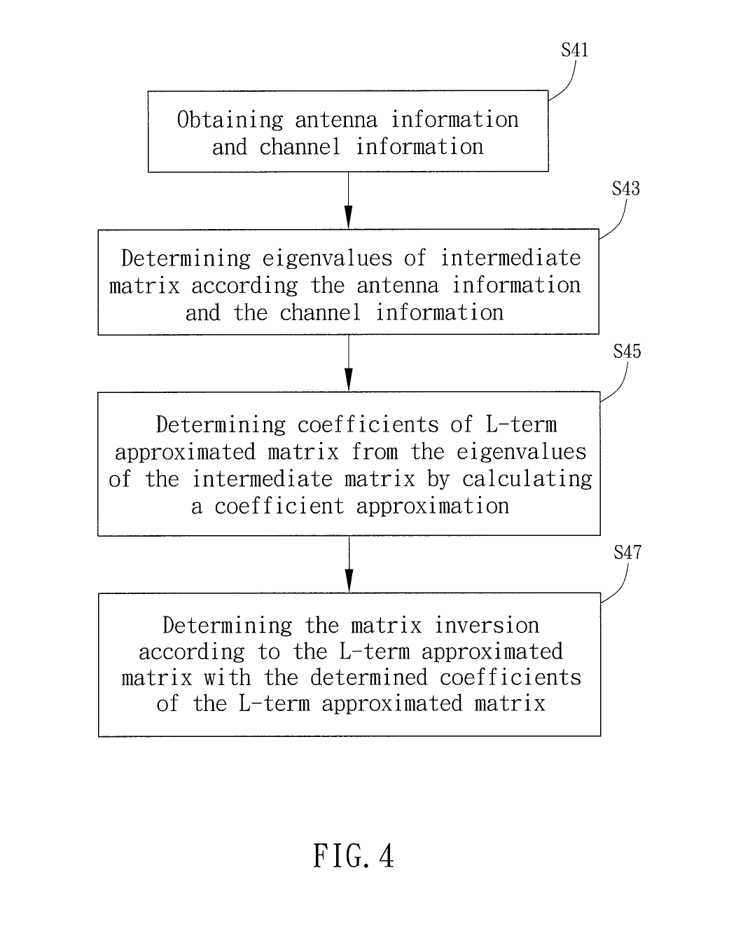

FIG. 4 is a flow chart illustrating method for MIMO communication in accordance with an embodiment of the present disclosure. In step S41, the processing module 29 of the BS 20 obtains antenna information and channel information. The antenna information may include not only the number N of the antennas 21 but also the number K of the UEs 30. The channel information may include the average power of the channel matrix H.

In step S43, the processing module 29 of the BS 20 determines eigenvalues ϕₖ of an intermediate matrix B according the antenna information and the channel information, where the intermediate matrix B is related to an L-term approximated matrix A_{L} for Neumann series expansion of the matrix inversion G⁻¹. Specifically, according to (1), the matrix inversion G⁻¹ can also be mathematically expressed as follow:

G⁻¹=D^{-1/2}(I+B+B²+ . . . )D^{-1/2} (3),

where I is an identity matrix, the intermediate matrix B is defined as B [symbol] −D^{-1/2}ED^{-1/2}, and D^{-1/2} is the matrix square root of D⁻¹. It is worthwhile noted that the intermediate matrix B and −D⁻¹E process identical eigenvalues and hence the series (3) converges if and only if (1) converges.

In order to improve performance, a modified L-term approximated matrix for Neumann series expansion of the matrix inversion G⁻¹ is considered, which is mathematically expressed as follows:

$$\begin{matrix}{A}_{L} {=}^{Δ} {D}^{- 1 / 2} ( {\sum }_{l = 0}^{L - 1} {α}_{l} {B}^{l} ) {D}^{- 1 / 2} & ( 4 ) \\ = {\sum }_{l = 0}^{L - 1} {{α}_{l} ( - {D}^{- 1} E )}^{l} {D}^{- 1} & ( 5 )\end{matrix}$$

where [symbol] are coefficients of the L-term approximated matrix A_{L}.

In the present disclosure, a coefficient approximation is a coefficient estimation procedure to calculate the coefficients [symbol] of the L-term approximated matrix A_{L}, and the coefficient approximation can be mathematically expressed as follows:

$$[ \begin{matrix}\frac{1}{1 - {φ}_{1}} \\ \frac{1}{1 - {φ}_{2}} \\ ⋮ \\ \frac{1}{1 - {φ}_{K}}\end{matrix} ] \approx [ \begin{matrix}1 & {φ}_{1} & … & {φ}_{1}^{L - 1} \\ 1 & {φ}_{2} & … & {φ}_{2}^{L - 1} \\ ⋮ & ⋮ & ⋮ & ⋮ \\ 1 & {φ}_{K} & … & {φ}_{K}^{L - 1}\end{matrix} ] [ \begin{matrix}{α}_{0} \\ {α}_{1} \\ ⋮ \\ {α}_{L - 1}\end{matrix} ] , \qquad ( 6 )$$

where ϕ₁˜ϕ_{K} are the eigenvalues of the intermediate matrix B, and α₁˜α_{K} are the coefficients of the L-term approximated matrix A_{L}.

The processing module 29 of the BS 20 may determine the eigenvalues ϕₖ of the intermediate matrix B according to an eigenvalue transformation which is mathematically expressed as follows:

$${φ}_{k} \approx 1 - \frac{{λ}_{k}}{N} = 1 - \frac{N {\hat{c}}^{2}}{} , \qquad ( 7 )$$

k is a positive integer where 1≤k≤K, λₖ is eigenvalue of the K×K matrix G, λₖ= [symbol] /ĉ², ĉ=\sqrt{K/P_{H}}, and P_{H} is the average power of the channel matrix H according to the channel information in which P_{H}=tr{HH^{H}}. The approximation for the eigenvalue [symbol] follows the Marcenko-Pastur law based on the random matrix theory. If a normalized random matrix is considered with the number N of the antennas 21 and the number K of the UEs 30 approaching infinity, the distribution of eigenvalues may approach Marcenko-Pastur distribution. The probability density function of Marcenko-Pastur distribution can be approximated to a K-bin probability histogram with non-uniform bin-widths where each bin is designed to contain 1/K of probability mass. Therefore, the approximation for the eigenvalue [symbol] can be obtained according to the probability histogram.

It should be noticed that, there may be lots of methods for calculating eigenvalues λₖ of the K×K matrix G or eigenvalues ϕₖ of the intermediate matrix B. For example, if the channel matrix H is correlated, the coefficient correlation of the channel matrix H would be taken into account, and the eigenvalue transformation would need to be modified; alternatively, Bisection method, Laguerre iteration, and the like may be implemented with the needed information. However, the proposed eigenvalue transformation has a less computational complexity.

In step S45, the processing module 29 of the BS 20 determines the coefficients αₖ of the L-term approximated matrix A_{L} from the eigenvalues ϕₖ of the intermediate matrix B by calculating the coefficient approximation (such as equation (6)). In the present embodiment, the eigenvalues ϕₖ of the intermediate matrix B determined at step S43 is obtained, and then the processing module 29 determines an optimized result of the coefficient approximation through a curve fitting procedure which is a least-squares (LS) approximation.

It should be noted that, for curve fitting procedure, LS approximation is adopted because of its low complexity. In LS approximation, the L2 norm of the residual (i.e. left-hand side of coefficient approximation minus the right-hand side of coefficient approximation) is minimized. One can also minimizes L1 norm, or the L-infinity norm instead, which both can be converted to linear-programming problems and can be solved using Simplex methods or interior point methods (with higher complexity). Another possible way for curve fitting procedure is to use total-least-squares (TLS) approximation instead of LS approximation. However, LS approximation has less computational complexity than TLS approximation.

In step S47, the processing module 29 of the BS 20 determines the matrix inversion G⁻¹ according to the L-term approximated matrix with the determined coefficients αₖ. In other words, the coefficients αₖ determined at step S45 is used to construct the L-term approximated matrix A_{L}, so as to determine the matrix inversion G⁻¹. As a result, the matrix inversion G⁻¹ can be applied on ZF precoding or equalization such as the unnormalized precoder \tilde{F} and the equalizer W. For example, the matrix inversion G⁻¹=(H^{H}H)⁻¹ is substituted in the equalizer W=(H_{UL}^{H}H_{UL})⁻¹H_{UL}^{H}.

It should be noted that, while the proposed method of the present embodiment is developed for finding an approximation for the matrix inversion (G⁻¹=(H^{H}H)⁻¹), it can be extended in other embodiments to find an approximation for G⁻¹ with Ğ=G+ξI_{K}, where ξ>0 is a constant that appears in minimum-mean-square-error (MMSE) or regularized ZF precoders/equalizers. The modified eigenvalue transformation would be

$${\breve{φ}}_{k} = {eig}_{k} ( \breve{B} ) = \frac{N}{N + ξ} - \frac{( N + ξ ) {\hat{c}}^{2}}{} .$$

In the proposed method, only the antenna information such as the number N of the antennas 21 and the number K of the UEs 30 would be needed for determining the eigenvalues ϕₖ of an intermediate matrix B, and the determined result can be pre-stored in the memory module 22, so that the processing module 29 would not need to determine the eigenvalues ϕₖ. In addition, the eigenvalue transformation is merely related to the average power P_{H} of the channel matrix H instead of instant values of the channel matrix H. Comparing with the instant values of the channel matrix H, the average power P_{H} has less variation, so that the processing module 29 does not need to update the average power P_{H} or calculate the average power P_{H} all the time. Furthermore, the implementation complexity of the L-term approximated matrix is almost the same with the conventional Neumann series expansion based method, but the presented method has higher precision.

It should be noted that, aforementioned embodiment is used for the communication system 1 including K first communication devices with single antenna such as the UEs 30 and a second communication device with N antennas such as the BS 20. However, based on the spirit of the aforementioned embodiment, the proposed method may be utilized on the UEs 30 or other UE with multiple antennas. It means the processing module of UEs 30 or other UE with multiple antennas such as processing module 39 may perform the operation of equalizer/precoder.

In conclusion, the present disclosure provides the method for MIMO system. In contrast to the existing methods which are mostly derived from the Neumann series expansion framework, additional coefficients have been introduced in the proposed method to enhance the precision of approximation. Efficient algorithm for the coefficient design is presented which includes the eigenvalue transformation based on the random matrix theory and the curve fitting procedure for optimizing the coefficients. With the enhancement of the approximation precision, lower error probability and higher spectrum efficiency would be achieved. In addition, the proposed method exhibits practically similar computational complexity while achieving substantial performance enhancement compared to other existing method.

The above description represents merely the preferred embodiment of the present disclosure, without any intention to limit the scope of the present disclosure. The simple variations and modifications not to be regarded as a departure from the spirit of the disclosure are intended to be included within the scope of the following claims.

1. A method for multiple-input-multiple-output (MIMO) communication, adapted for a communication device, comprising:
obtaining antenna information and channel information of the communication device;
determining eigenvalues of an intermediate matrix according to the antenna information and the channel information, wherein the intermediate matrix is related to an L-term approximated matrix for Neumann series expansion of a matrix inversion, the matrix inversion is an inverse of a K×K matrix, L is a positive integer, and K is a positive integer according to the antenna information;
determining coefficients of the L-term approximated matrix from the eigenvalues of the intermediate matrix by calculating a coefficient approximation, wherein the coefficient approximation is mathematically expressed as
$$[ \begin{matrix}\frac{1}{1 - {φ}_{1}} \\ \frac{1}{1 - {φ}_{2}} \\ M \\ \frac{1}{1 - {φ}_{K}}\end{matrix} ] \approx [ \begin{matrix}1 & {φ}_{1} & Λ & {φ}_{1}^{L - 1} \\ 1 & {φ}_{2} & Λ & {φ}_{2}^{L - 1} \\ M & M & M & M \\ 1 & {φ}_{K} & Λ & {φ}_{K}^{L - 1}\end{matrix} ] [ \begin{matrix}{α}_{0} \\ {α}_{1} \\ M \\ {α}_{L - 1}\end{matrix} ] ,$$
ϕ₁^{˜}ϕ_{K} are the eigenvalues of the intermediate matrix, and α₁^{˜}α_{K} are the coefficients of the L-term approximated matrix;
determining the matrix inversion according to the L-term approximated matrix with the determined coefficients of the L-term approximated matrix; and
applying the matrix inversion for precoding transmit data or equalization on received data.

2. The method for MIMO communication as claimed in claim 1, wherein determining the eigenvalues of the intermediate matrix according to the antenna information and the channel information comprises:
determining the eigenvalues of the intermediate matrix according to an eigenvalue transformation, wherein the eigenvalue transformation is mathematically expressed as
$${φ}_{k} \approx 1 - \frac{{λ}_{k}}{N} = 1 - \frac{N {\hat{c}}^{2}}{} ,$$
k is a positive integer where 1≤k≤K, λₖ is eigenvalue of the K×K matrix, N is a positive integer according to the antenna information, λₖ= [symbol] /ĉ², ĉ=\sqrt{K/P_{H}}, and P_{H} is an average power of channel matrix according to the channel information.

3. The method for MIMO communication as claimed in claim 1, wherein calculating the coefficient approximation comprises:
determining an optimized result of the coefficient approximation through a curve fitting procedure.

4. The method for MIMO communication as claimed in claim 3, wherein the curve fitting procedure is a least-squares approximation.

5. The method for MIMO communication as claimed in claim 1, wherein the L-term approximated matrix is mathematically expressed as
$${D}^{- 1 / 2} ( {\sum }_{λ = 0}^{L - 1} {α}_{λ} {B}^{λ} ) {D}^{- 1 / 2} ,$$
D is a diagonal matrix related to the K×K matrix, α_{λ} is the coefficient of the L-term approximated matrix, and B is the intermediate matrix.

6. (canceled)

7. A communication device for MIMO communication, comprising:
a transmitting module, transmitting data;
a receiving module, receiving data; and
a processor, coupled to the transmitting module and the receiving module, and configured at least for:
obtaining antenna information and channel information;
determining eigenvalues of an intermediate matrix according to the antenna information and the channel information, wherein the intermediate matrix is related to an L-term approximated matrix for Neumann series expansion of a matrix inversion, the matrix inversion is an inverse of a K×K matrix, L is a positive integer, and K is a positive integer according to the antenna information;
determining coefficients of the L-term approximated matrix from the eigenvalues of the intermediate matrix by calculating a coefficient approximation, wherein the coefficient approximation is mathematically expressed as
$$[ \begin{matrix}\frac{1}{1 - {φ}_{1}} \\ \frac{1}{1 - {φ}_{2}} \\ M \\ \frac{1}{1 - {φ}_{K}}\end{matrix} ] \approx [ \begin{matrix}1 & {φ}_{1} & Λ & {φ}_{1}^{L - 1} \\ 1 & {φ}_{2} & Λ & {φ}_{2}^{L - 1} \\ M & M & M & M \\ 1 & {φ}_{K} & Λ & {φ}_{K}^{L - 1}\end{matrix} ] [ \begin{matrix}{α}_{0} \\ {α}_{1} \\ M \\ {α}_{L - 1}\end{matrix} ] ,$$
ϕ₁^{˜}ϕ_{K} are the eigenvalues of the intermediate matrix, and α₁^{˜}α_{K} are the coefficients of the L-term approximated matrix;
determining the matrix inversion according to the L-term approximated matrix with the determined coefficients of the L-term approximated matrix; and
applying the matrix inversion for precoding transmit data or equalization on received data.

8. The communication device for MIMO communication as claimed in claim 7, wherein the processor is further configured at least for:
determining the eigenvalues of the intermediate matrix according to an eigenvalue transformation, wherein the eigenvalue transformation is mathematically expressed as
$${φ}_{k} \approx 1 - \frac{{λ}_{k}}{N} = 1 - \frac{N {\hat{c}}^{2}}{} , \qquad$$
k is a positive integer where 1≤k≤K, λₖ is eigenvalue of the K×K matrix, N is a positive integer according to the antenna information, λₖ= [symbol] /ĉ², ĉ=\sqrt{K/P_{H}}, and P_{H} is an average power of channel matrix according to the channel information.

9. The communication device for MIMO communication as claimed in claim 7, wherein the processor is further configured at least for:
determining an optimized result of the coefficient approximation through a curve fitting procedure.

10. The communication device for MIMO communication as claimed in claim 9, wherein the curve fitting procedure is a least-squares approximation.

11. The communication device for MIMO communication as claimed in claim 7, wherein the L-term approximated matrix is mathematically expressed as
$${D}^{- 1 / 2} ( {\sum }_{λ = 0}^{L - 1} {α}_{λ} {B}^{λ} ) {D}^{- 1 / 2} ,$$
D is a diagonal matrix related to the K×K matrix, α_{λ} is the coefficient of the L-term approximated matrix, and B is the intermediate matrix.

12. (canceled)

13. A communication system for MIMO communication, comprising:
K first communication devices, each of the communication devices comprising single antenna, and K being a positive integer;
a second communication device, comprising N antennas, wherein N is a positive integer, and the second communication device is configured at least for:
obtaining antenna information and channel information;
determining eigenvalues of an intermediate matrix according to the antenna information and the channel information, wherein the intermediate matrix is related to an L-term approximated matrix for Neumann series expansion of a matrix inversion, the matrix inversion is an inverse of a K×K matrix, L is a positive integer, and K is determined according to the antenna information;
determining coefficients of the L-term approximated matrix from the eigenvalues of the intermediate matrix by calculating a coefficient approximation, wherein the coefficient approximation is mathematically expressed as
$$[ \begin{matrix}\frac{1}{1 - {φ}_{1}} \\ \frac{1}{1 - {φ}_{2}} \\ M \\ \frac{1}{1 - {φ}_{K}}\end{matrix} ] \approx [ \begin{matrix}1 & {φ}_{1} & Λ & {φ}_{1}^{L - 1} \\ 1 & {φ}_{2} & Λ & {φ}_{2}^{L - 1} \\ M & M & M & M \\ 1 & {φ}_{K} & Λ & {φ}_{K}^{L - 1}\end{matrix} ] [ \begin{matrix}{α}_{0} \\ {α}_{1} \\ M \\ {α}_{L - 1}\end{matrix} ] ,$$
ϕ₁^{˜}ϕ_{K} are the eigenvalues of the intermediate matrix, and α₁^{˜}α_{K} are the coefficients of the L-term approximated matrix;
determining the matrix inversion according to the L-term approximated matrix with the determined coefficients of the L-term approximated matrix; and
applying the matrix inversion for precoding transmit data or equalization on received data.

14. The communication system for MIMO communication as claimed in claim 13, wherein the second communication device is further configured at least for:
determining the eigenvalues of the intermediate matrix according to an eigenvalue transformation, wherein the eigenvalue transformation is mathematically expressed as
$${φ}_{k} \approx 1 - \frac{{λ}_{k}}{N} = 1 - \frac{N {\hat{c}}^{2}}{} ,$$
k is a positive integer where 1≤k≤K, λₖ is eigenvalue of the K×K matrix, N is a positive integer according to the antenna information, λₖ= [symbol] /ĉ², ĉ=\sqrt{K/P_{H}}, and P_{H} is an average power of channel matrix according to the channel information.

15. The communication system for MIMO communication as claimed in claim 13, wherein the second communication device is further configured at least for:
determining an optimized result of the coefficient approximation through a curve fitting procedure.

16. The communication system for MIMO communication as claimed in claim 15, wherein the curve fitting procedure is a least-squares approximation.

17. The communication system for MIMO communication as claimed in claim 13, wherein the L-term approximated matrix is mathematically expressed as
$${D}^{- 1 / 2} ( {\sum }_{λ = 0}^{L - 1} {α}_{λ} {B}^{λ} ) {D}^{- 1 / 2} ,$$
D is a diagonal matrix related to the K×K matrix, α_{λ} is the coefficient of the L-term approximated matrix, and B is the intermediate matrix.

18. (canceled)
